(19) United States
(12) Patent Application Publication
(10) Pub. No.: US 2014/0351745 A1
(43) Pub. Date: Nov. 27, 2014

(54) CONTENT NAVIGATION HAVING A SELECTION FUNCTION AND VISUAL INDICATOR THEREOF

(71) Applicant: International Business Machines Corporation, Armonk, NY (US)

(72) Inventor: Lauren M. Shupp, Blacksburg, VA (US)

(73) Assignee: International Business Machines Corporation, Armonk, NY (US)

(21) Appl. No.: 13/899,801

(22) Filed: May 22, 2013

(51) Int. Cl. G06F 3/0485

(52) U.S. Cl. CPC G06F 3/0485
USPC 715/784

(57) ABSTRACT

Exemplary embodiment provides methods and systems for providing content navigation having a selection function and visual indicator thereof. Aspects of exemplary embodiment include displaying on a display screen as part of a user interface a series of navigation indicators corresponding to a series of content items available for viewing; displaying a current item indicator in association with a first one of the navigation indicators of a first content item indicating that the first content item is in view on the display; in response to receiving a selection of the first content item, displaying a selection indicator in association with at least the first content item and the first navigation indicator to indicate that the first displayed content item is selected; and in response to receiving a scroll operation, displaying a second content item on the display in place of the first content item, and displaying the current item indicator in association with a second one of the navigation indicators of the second content item, while maintaining the display of the selection indicator to indicate that the first content item remains selected, but out of view.

### BACKGROUND

On graphical user interfaces of mobile devices, and even desktop applications, dots are often used to represent the number of pages available for viewing by the user on a display. This paging technique is often used for touch screen devices where a dot corresponding to a currently viewed page is displayed in a different color than the dots representing pages not in view. An adjacent page can be displayed by the user by swiping or panning left and right on the display either with a finger or a mouse.

In many designs, this same type of paging technique is desired. However in current implementations, there is only a visual cue indicating the page currently being viewed. No other navigation or selection options are provided.

Accordingly, it would be desirable to provide an improved method and system for providing content navigation, and more particularly, for providing enhanced dot navigation.

### BRIEF SUMMARY

The exemplary embodiment provides methods and systems for providing content navigation having a selection function and visual indicator thereof. Aspects of exemplary embodiment include displaying on a display screen as part of a user interface a series of navigation indicators corresponding to a series of content items available for viewing; displaying a current item indicator in association with a first one of the navigation indicators of a first content item indicating that the first content item is in view on the display; in response to receiving a selection of the first content item, displaying a selection indicator in association with at least the first content item and the first navigation indicator to indicate that the first displayed content item is selected; and in response to receiving a scroll operation, displaying a second content item on the display in place of the first content item, and displaying the current item indicator in association with a second one of the navigation indicators of the second content item, while maintaining the display of the selection indicator to indicate that the first content item remains selected, but out of view.

### BRIEF DESCRIPTION OF SEVERAL VIEWS OF THE DRAWINGS

FIG. 1 is a block diagram illustrating an exemplary system environment in which one embodiment for providing content navigation having a selection function and selection visual indicator may be implemented.

FIG. 2 is a block diagram illustrating a process for providing content navigation having a selection function and a selection indicator in accordance with an exemplary embodiment.

FIGS. 3A-3C are block diagrams illustrating a series of navigation indicators on display screen.

FIGS. 4A-4D are diagrams illustrating a content navigation process having a selection function in which the content items represent contacts (or alternatively portrait photographs), and the navigation indicators comprise thumbnail pictures of the contacts.

### DETAILED DESCRIPTION

The exemplary embodiment relates to methods and systems for providing content navigation having a selection function and visual indicator thereof. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

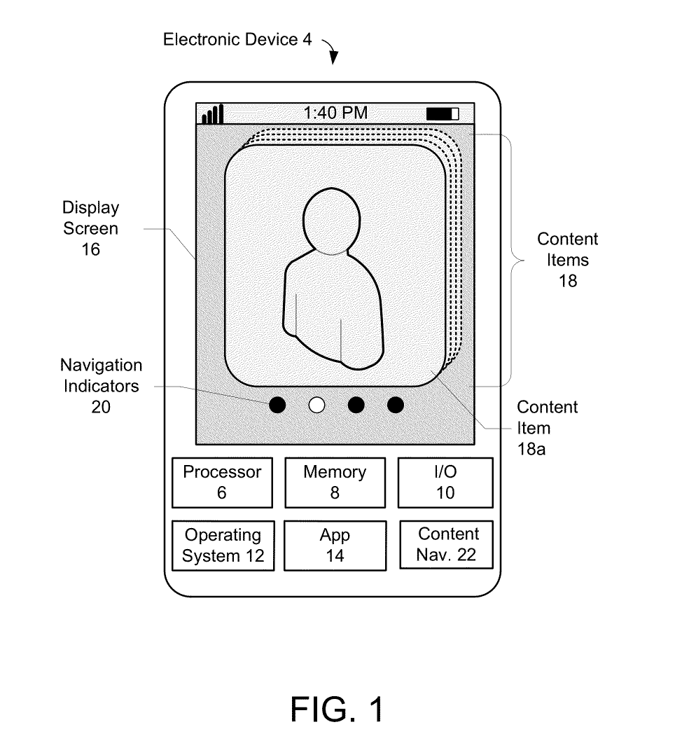

FIG. 1 is a block diagram illustrating an exemplary system environment in which one embodiment for providing content navigation having a selection function and selection visual indicator may be implemented. The system includes an electronic device 4 having at least one processor 6, a memory 8, input/output (I/O) 10, an operating system 12, at least one application (app) 14, and a display screen 16. The processor 6, memory 8 and I/O 10 may be coupled together via a system bus (not shown). The OS 12 and the app 14 reside in memory and are executed by the processor 6.

When running, OS 12 and/or the app 14 may include a user interface (UI) configured to sequentially display content items 18 on the display screen 16 in response to swiping or paging operations performed by a user. Commonly, the content items 18 represent pages, but may also comprise pictures, contacts and the like.

On mobile devices as well as desktop applications, navigation indicators 20, shown here as dots, may represent the number of content items 18 available for viewing. Usually, one content item 18a may be shown at a time. The other content items 18 shown with dashed lines are not visible. Conventionally, the navigation indicator displayed in a different color (e.g., white) than the other navigation indicators (black) represents the content item 18a currently displayed.

One problem with conventional paging techniques using dot navigation is that such techniques do not allow the user to select a page and continue scrolling without losing the selection, rather there is just a visual cue indicating the page currently being viewed.

According to an exemplary embodiment, the electronic device 4 is provided with a content navigation component 22 that enables a user to select a currently displayed content item 18, and in response, displays a selection indicator associated with the navigation indicator of the selected content item, the display of which persist even when the user navigates away from the selected page, as described below.

Although the content navigation component 22 is shown as a single component, it should be understood that the functions of the content navigation component 22 may be implemented using a different number of software components. In addition, the content navigation component 22 may be implemented as part of the OS 12, the application 14, or as a separate application.

The electronic device 4 may be implemented as any type of computing device that displays content on a display screen 16, such as a smart or mobile phone, a tablet computer, a personal computer (e.g., desktop, laptop, or notebook), a set top box, a TV, a game system, and the like. The electronic device 4 may include hardware components of typical computing devices, including input devices, such as, a keyboard, pointing device, a microphone, and buttons (not shown), and output devices, such as speakers, and the like (not shown). The memory 8 may comprise various types of computer-readable media, e.g., flash memory, hard drive, optical disk drive, magnetic disk drive, and the like, containing computer instructions that implement the functionality disclosed when executed by the processor. The electronic device 4 may further include wired or wireless network communication interfaces for communication.

The processor 6 may be part of data processing system suitable for storing and/or executing software code, which may comprise the operating system 12 and various applications. The processor 6 may be coupled directly or indirectly to elements of the memory 8 through a system bus (not shown). The memory elements can include local memory employed during actual execution of the program code, bulk storage, and cache memories which provide temporary storage of at least some program code in order to reduce the number of times code must be retrieved from bulk storage during execution.

The input/output 10 or I/O devices can be coupled to the system either directly or through intervening I/O controllers. Network adapters (not shown) may also be coupled to the system to enable the data processing system to become coupled to other data processing systems or remote printers or storage devices through intervening private or public networks. Modems, cable modems and Ethernet cards are just a few of the currently available types of network adapters.

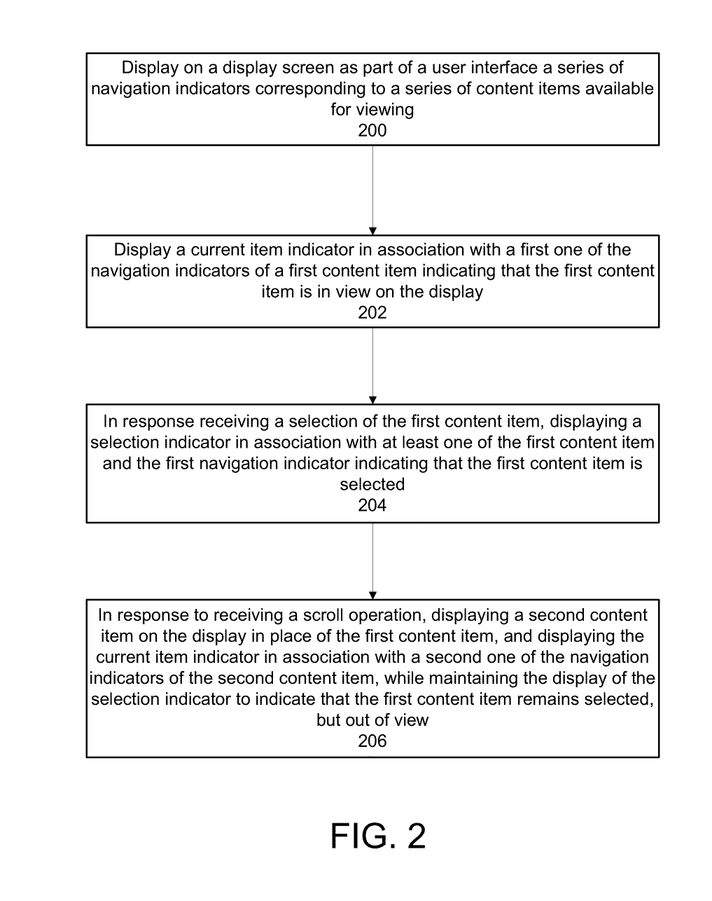

FIG. 2 is a block diagram illustrating a process for providing content navigation having a selection function and a selection indicator in accordance with an exemplary embodiment. In one embodiment the process is performed by a software component, such as the content navigation component 22. In an alternative embodiment, the process may be performed by any combination of the content navigation component 22, the operating system 12 and the application 14.

The process may begin by displaying on a display screen as part of a user interface a series of navigation indicators corresponding to a series of content items available for viewing (block 200).

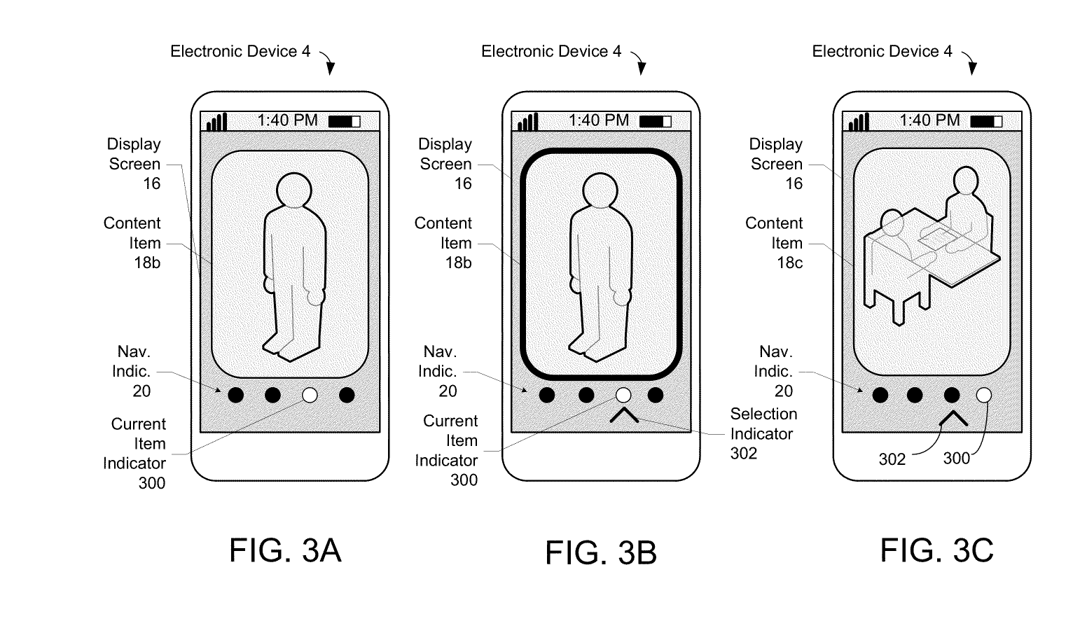

FIGS. 3A-3C are block diagrams illustrating a series of navigation indicators 20 on display screen 16. Referring to FIG. 3A, a series of four navigation indicators 20 are displayed indicating that there are four content items 18a-18d (collectively 18) available for viewing, where content item 18b is the currently displayed content item. Although four navigation indicators 20 are shown, any number of two or more navigation indicators 20 may be displayed.

In addition, although the navigation indicators 20 are shown as dots, any type of visual affordance may be displayed (e.g., different shapes, icons, pictures, alphanumeric characters and the like).

In one embodiment, the content items 18 may each comprise pages of an application, document, website or OS screens; pictures, contacts, document, folders, calendar entries (e.g., days, weeks, months or tasks), database entries, maps, and the like.

Referring again to FIG. 2, a current item indicator is displayed in association with a first one of the navigation indicators of a first content item indicating that the first content item is in view on the display (block 202). As described above, the current item indicator may be similar to the other navigation indicators, but is typically displayed differently than the other navigation indicators.

Referring again to FIG. 3A, a current item indicator 300 is shown in association with the third navigational indicator 20, indicating that the content item 18b is the third content item and is currently displayed.

Referring again to FIG. 2, in response to receiving a selection of the first displayed content item, a selection indicator is displayed in association with at least the first content item and the first navigation indicator indicating that the first displayed content item is selected (block 204).

Referring to FIG. 3B, the user interface of the electronic device 4 is shown after the user has selected the currently displayed item 18b. According to the exemplary embodiments, in response, a selection indicator 302 is displayed in association with the navigation indicator 300 of the currently displayed item 18b to indicate that the content item 18b has been selected.

Although the selection indicator 302 is shown in this example as an arrow displayed beneath the current item indicator 300, the selection indicator 302 may comprise any type of visual affordance. Examples may include different shapes (e.g., an underline, circle, square, etc.), highlights or flashes, icons, pictures, alphanumeric characters, animations and the like). In addition, the selection indicator 302 may be displayed as at least one of adjacent to the current item indicator 300, in place of the current item indicator 300, and/or adjacent to or over the currently displayed content item 18b, where adjacent means next to any side of the object, including surrounding the object.

According to the exemplary embodiments, when the selection of the content item 18b is made, the selection indicator 302 may also include a temporary component, such as a highlight displayed around the current content item 18b, as shown in FIG. 3B. In this embodiment, the temporary component may disappear after a predetermined amount of time and/or in response to the user navigating to a different content item.

In a further embodiment, the user may be allowed to select more than one content item by repeating the navigation and select operations. In yet another embodiment, the selection indicator may further display actions that the user may take with respect to the selected content item.

In one embodiment, receiving a selection of the first displayed content item may comprise the content navigation component 22 being configured to receive a selection input by way of detection of a tap on a touchscreen or mouse click over the displayed content item 18b, or a voice command (e.g., “select that”). The content navigation component 22, the OS 12, or the application 14 may perform detection of the selection.

Referring again to FIG. 2, in response to receiving a scroll operation, a second content item is displayed on the display screen in place of the first content item, and the current item indicator is displayed in association with a second one of the navigation indicators of the second content item, while maintaining the display of the selection indicator to indicate that the first content item remains selected, but out of view (block 206).

For example, referring to FIG. 3C, the display screen 16 is shown after the user has navigated from content item 18b to content item 18c, and the current item indicator 300 moves to the navigation indicator 20 corresponding to content item 18c. However, according to the exemplary embodiment, the selection indicator 302 remains displayed with the navigation indicator representing content item 18b.

Thus, the content navigation process of the exemplary embodiment provides the user with a selection function and a selection indicator 302 that persists even if the selected content item is no longer in view. In one embodiment, display of the selection indicator 302 may persist until the user selects a new content item or cancels the selection (e.g., by selecting the content item again).

Example uses for selecting content items 18 during content navigation (e.g., dot navigation) may include the following. One example is where the content items represents pages, and each page may represent a step in a process. Assume the user selects a current step in the process, but wants to scroll left and right to view the pages for the read-only previous steps and future steps in the process flow for useful context. The original selected page remains selected and highlighted to make it easier for the user to identify and to navigate back to.

A second example is where the content items represent home pages showing installed applications, and the user may select one or more of these pages to indicate which applications are running.

A third example is where the user selects one or more the content items to take action on selected the content item. The selection indicator is provided to highlighting the selected content item, confirming the user's choice.

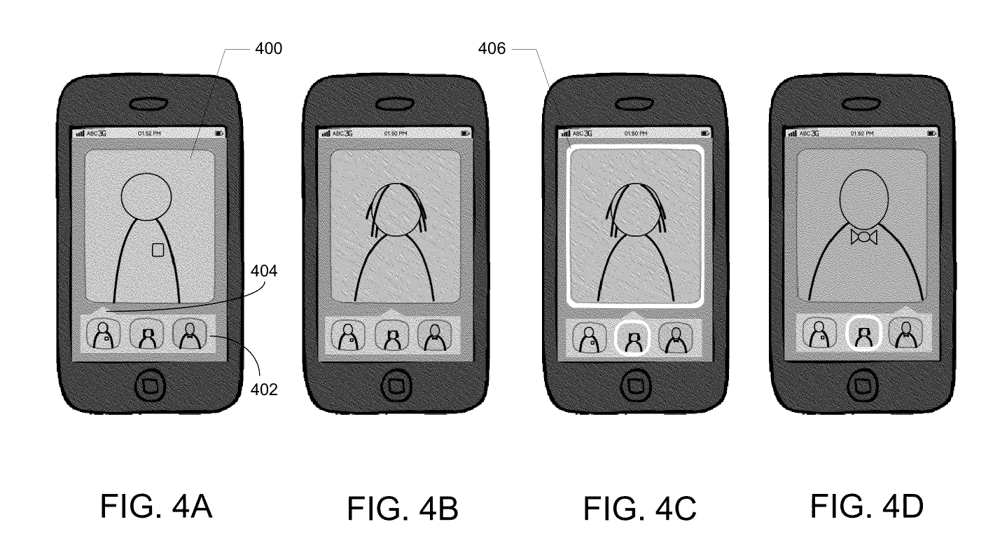

FIGS. 4A-4D are diagrams illustrating a content navigation process having a selection function in which the content items 400 represent contacts (or alternatively portrait photographs), and the navigation indicators 402 comprise thumbnail pictures of the contacts. The current item indicator 404 is shown displayed as an arrow above the navigation indicator corresponding to the currently displayed contact. FIG. 4C shows the selection indicator 406 in this example comprising a highlight displayed around both the selected content item and the corresponding navigation indicator.

According to the exemplary embodiment, the content navigation having a selection function and indicator of the selection shows the user which content item is selected or in focus as a reminder for the user to return back to the selected content item and to perhaps to take some action on it.

A method and system for providing content navigation having a selection function and a selection indicator has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for providing content navigation performed by at least one software component executing on at least one processor, comprising:
displaying on a display screen as part of a user interface a series of navigation indicators corresponding to a series of content items available for viewing;
displaying a current item indicator in association with a first one of the navigation indicators of a first content item indicating that the first content item is in view on the display;
in response to receiving a selection of the first content item, displaying a selection indicator in association with at least the first content item and the first navigation indicator to indicate that the first displayed content item is selected; and
in response to receiving a scroll operation, displaying a second content item on the display in place of the first content item, and displaying the current item indicator in association with a second one of the navigation indicators of the second content item, while maintaining the display of the selection indicator to indicate that the first content item remains selected, but out of view.

2. The method of claim 1, further comprising: displaying the navigation indicators as any type of visual affordance, including different shapes, icons, pictures, alphanumeric characters.

3. The method of claim 2, wherein the navigation indicators comprise dots.

4. The method of claim 1, wherein the content items comprise at least one of pages of an application, document, website or OS screens; pictures, contacts, document, folders, calendar entries, database entries, and maps.

5. The method of claim 1, wherein displaying a current item indicator further comprises: displaying the selection indicator in association with the navigation indicator corresponding to the selected content item.

6. The method of claim 1, further comprising: allowing a user to select more than one content item.

7. The method of claim 1, further comprising displaying the selection indicator as any type of visual for instance including different shapes, highlights, flashes, icons, pictures, of numeric characters and animations.

8. The method of claim 1 further comprising displaying the selection indicator as at least one of: adjacent to the current item indicator, in place of the current item indicator, and adjacent to or over the first content item.

9. The method of claim 1, further comprising: displaying the selection indicator with a temporary component displayed around the first content item that disappears after a predetermined amount of time and/or in response to a user navigating to a different content item.

10. An executable software product stored on a computer-readable storage medium containing program instructions for providing content navigation, the program instructions for:
displaying on a display screen as part of a user interface a series of navigation indicators corresponding to a series of content items available for viewing;
displaying a current item indicator in association with a first one of the navigation indicators of a first content item indicating that the first content item is in view on the display;
in response to receiving a selection of the first content item, displaying a selection indicator in association with at least the first content item and the first navigation indicator to indicate that the first displayed content item is selected; and
in response to receiving a scroll operation, displaying a second content item on the display in place of the first content item, and displaying the current item indicator in association with a second one of the navigation indicators of the second content item, while maintaining the display of the selection indicator to indicate that the first content item remains selected, but out of view.

11. The executable software product of claim 10, further comprising program instructions for: displaying the navigation indicators as any type of visual affordance, including different shapes, icons, pictures, alphanumeric characters.

12. The executable software product of claim 11, wherein the navigation indicators comprise dots.

13. The executable software product of claim 10, wherein the content items comprise at least one of pages of an application, document, website or OS screens; pictures, contacts, document, folders, calendar entries, database entries, and maps.

14. The executable software product of claim 10, wherein displaying a current item indicator further comprises: displaying the selection indicator in association with the navigation indicator corresponding to the selected content item.

15. The executable software product of claim 10, further comprising program instructions for: allowing a user to select more than one content item.

16. The executable software product of claim 10 further comprising program instructions for displaying the selection indicator as any type of visual for instance including different shapes, highlights, flashes, icons, pictures, of numeric characters and animations.

17. The executable software product of claim, 10 further comprising program instructions for displaying the selection indicator as at least one of: adjacent to the current item indicator, in place of the current item indicator, and adjacent to or over the first content item.

18. The executable software product of claim 10, further comprising program instructions for: displaying the selection indicator with a temporary component displayed around the first content item that disappears after a predetermined amount of time and/or in response to a user navigating to a different content item.

19. An electronic device, comprising:
a memory;
a processor coupled to the memory; and
a first application executed by the processor that is configured to:
display on a display screen as part of a user interface a series of navigation indicators corresponding to a series of content items available for viewing;
display a current item indicator in association with a first one of the navigation indicators of a first content item indicating that the first content item is in view on the display;
in response to receiving a selection of the first content item, display a selection indicator in association with at least the first content item and the first navigation indicator to indicate that the first displayed content item is selected; and
in response to receiving a scroll operation, display a second content item on the display in place of the first content item, and display the current item indicator in association with a second one of the navigation indicators of the second content item, while maintaining the display of the selection indicator to indicate that the first content item remains selected, but out of view.

20. The electronic device of claim 19, wherein the navigation indicators are displayed as any type of visual affordance, including different shapes, icons, pictures, alphanumeric characters.

21. The electronic device of claim 20, wherein the navigation indicators comprise dots.

22. The electronic device of claim 19, wherein the content items comprise at least one of pages of an application, document, website or OS screens; pictures, contacts, document, folders, calendar entries, database entries, and maps.

23. The electronic device of claim 19, wherein the selection indicator is displayed in association with the navigation indicator corresponding to the selected content item.

24. The electronic device of claim 19, wherein a user is allowed to select more than one content item.

25. The electronic device of claim 19, wherein the selection indicator is displayed as any type of visual for instance including different shapes, highlights, flashes, icons, pictures, of numeric characters and animations.
